(19) United States
(12) Patent Application Publication
(10) Pub. No.: US 2015/0028757 A1
(43) Pub. Date: Jan. 29, 2015

(54) SINGLE WIRE LIGHTING DRIVER CONTROL

(71) Applicants: Dror MANOR, Herzliya (IL); Shafrir Romano, Rishon Letzion (IL)

(72) Inventors: Dror MANOR, Herzliya (IL); Shafrir Romano, Rishon Letzion (IL)

(73) Assignee: Shafrir Romano, Rishon Letzion (IL)

(21) Appl. No.: 14/337,253

(22) Filed: Jul. 22, 2014

Related U.S. Application Data
(60) Provisional application No. 61/859,310, filed on Jul. 29, 2013.

(51) Int. Cl. H05B 33/08; H05B 37/02

(52) U.S. Cl. CPC H05B 33/0809; H05B 37/0263; H05B 37/0272
USPC 315/200 R

(57) ABSTRACT

In embodiments of the present invention, there is provided a lighting control device connected in series with an AC supply line of a lighting driver at a control access point, wherein the lighting control device comprises an AC/DC converter configured to receive an input AC voltage from the AC supply line and to convert it to an output DC voltage. The lighting control device further comprises a lighting control circuit configured to use the output DC voltage as a power supply and to transmit control information to the driving unit.

### FIELD OF THE INVENTION

The present invention relates generally to lighting systems, and particularly to methods and systems of controlled LED lighting.

### BACKGROUND OF THE INVENTION

Light Emitting Diodes (LED)s have become a prevailing technology in the industry of lighting. In a typical LED lighting system there is a LED driving unit, shortly denoted LED driver, closely attached to one or more LED arrays. The LED driver operation is typically based on a Pulse Width Modulation (PWM) technique, wherein a user can control the width and optionally the amplitude of power pulses, at the LED driver output, for achieving desired lighting characteristics.

An advanced method and system for controlled driving of LEDs was suggested in our previous US patent application “Device and method for controlled LED lighting” the disclosure of which is incorporated herein by reference. In that publication, the LED driver receives control information from various control sources. An example control source is a dimmer, which imposes a variable dimming angle on the mains power that feeds the LED driver. Other control sources, such as various types of sensors or a remote controller, need dedicated power sources for their operation. Thus, in order to save system complexity, further wiring and power consumption, there is a need for an efficient remote controller for LED drivers, capable of operating without resorting to a dedicated power source.

### SUMMARY OF THE INVENTION

Accordingly, it is a principal object of the present invention to provide improved and efficient techniques of supplying power to a remote controller of a lighting driver, typically a LED driver. Such a remote controller is denoted herein as lighting control device for the sake of generality. In particular, the provided techniques save the need for a dedicated power supply for the lighting control device.

Thus, in accordance with an embodiment of the present invention, there is provided a lighting control device that controls a lighting driver. The lighting control device comprises an input stage connected along an AC supply line of the lighting driver, an AC/DC converter configured to receive an input AC voltage from the AC supply line and to convert it to an output DC voltage, and a lighting control circuit configured to receive the output DC voltage as a power source and to transmit control information to the driving unit.

In an embodiment, the input stage comprises a voltage limiter configured to determine the input AC voltage, and a limiter control circuit configured to reduce the input AC voltage when the AC/DC converter reaches an operating state, thereby saving power consumption of the voltage limiter.

In some embodiments, the limiter control circuit comprises a switch capable to shortcut a part of the voltage limiter for reducing the input AC voltage.

In some embodiments, the AC/DC converter comprises a voltage-raising stage, e.g. a transformer.

In an embodiment, the lighting control circuit comprises a wireless transmitter for transmitting the control information to the lighting driver, while in other embodiments the lighting control circuit is configured to transmit the control information to the lighting driver through the AC supply line either by means of an RF transformer or by means of a coupling capacitor.

In an embodiment, the lighting control device further comprises a user interface coupled to the lighting control circuit, whereas the lighting control circuit is further configured to receive one or more control commands from a user through the user interface and to produce the control information based on the control commands. An example of such a control command is a dimming command.

In accordance with an embodiment of the present invention, there is also provided a method of controlling a lighting driver comprising the steps of: Connecting a lighting control device along an AC supply line of the lighting driver, wherein the lighting control device comprises an input stage, an AC/DC converter and a lighting control circuit; converting an input current of the lighting driver flowing through the AC supply line to an input voltage to the AC/DC converter; converting the input AC voltage to an output DC voltage by the AC/DC converter; supplying the output DC voltage to a lighting control circuit; and transmitting control information to the lighting driver from the lighting control circuit.

These and other features and benefits of the invention disclosed herein will be more fully understood upon consideration of the following description and the accompanying drawings.

### BRIEF DESCRIPTION OF THE DRAWINGS

For a better understanding of the invention with regard to the embodiments thereof, reference is made to the accompanying drawings, in which like numerals designate corresponding elements or sections throughout, and in which:

FIGS. 1A, 1B and 1C are block diagrams that schematically illustrate lighting systems, in accordance with embodiments of the present invention; and

FIG. 2 is a flowchart that schematically illustrates a method of controlled driving of LEDs, in accordance with an embodiment of the present invention.

### DETAILED DESCRIPTION OF EMBODIMENTS

Embodiments of the present invention provide improved systems and methods for controlling a LED driver from a control access point, typically located on a wall, wherein an AC supply line of the LED driver, typically the live line, is accessible.

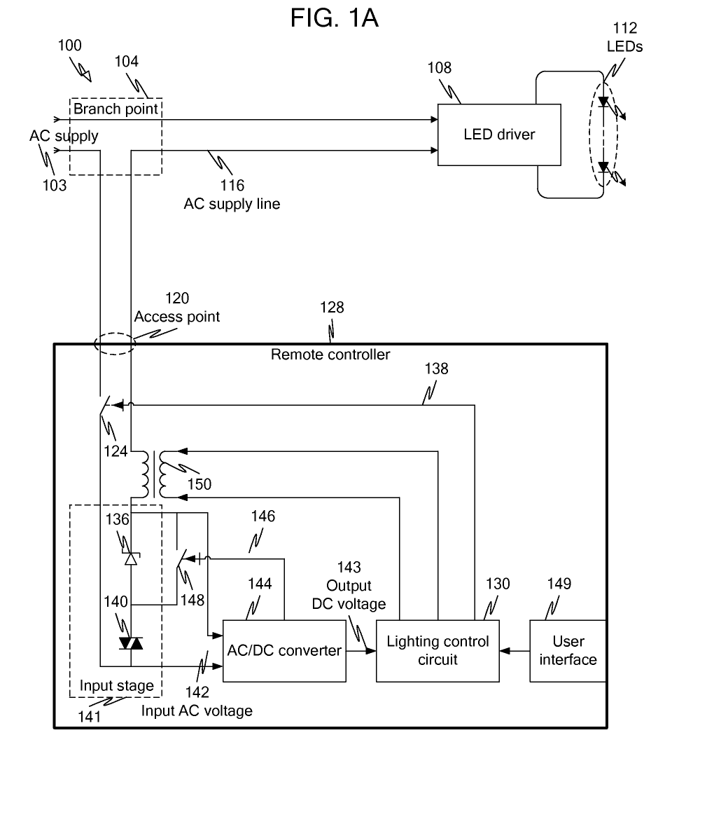

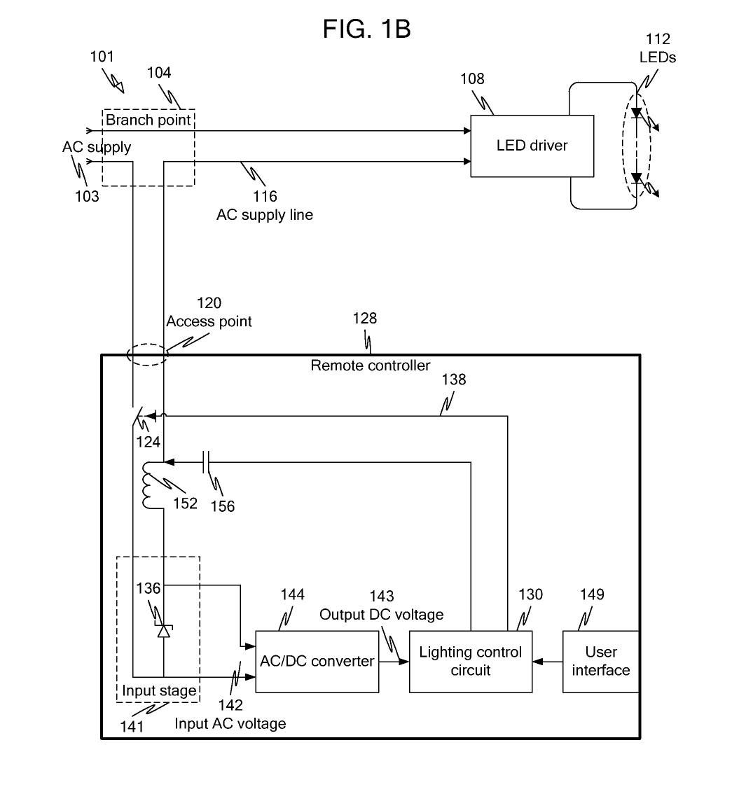

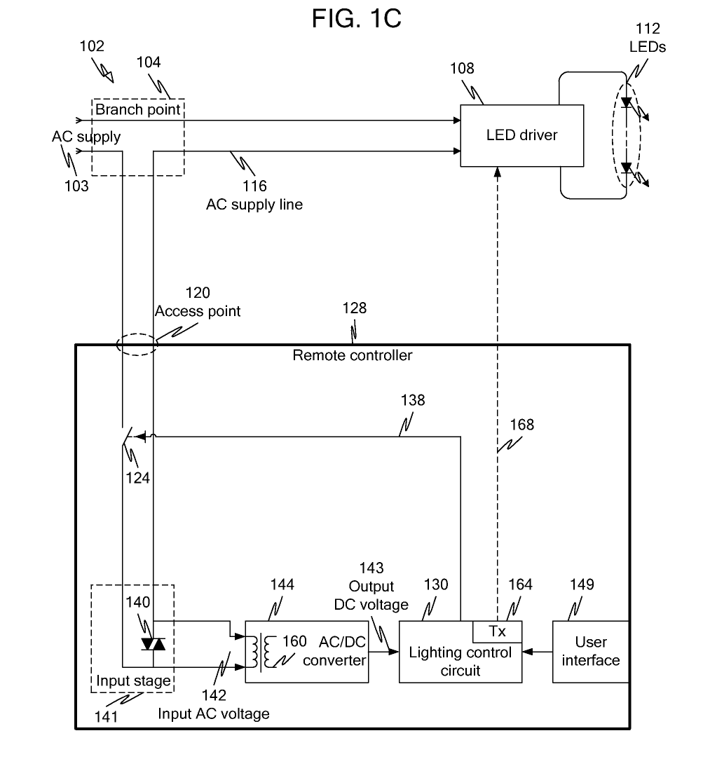

Referring to FIG. 1A, there is shown a block diagram that schematically illustrates a lighting system 100, in accordance with an embodiment of the present invention. System 100 is powered from an AC supply 103, typically a mains supply, through a branch point 104, which feeds a LED driver 108, to which a LED array 112 is connected. In branch point 104, an AC supply line 116, typically the mains live line, splits and drops to a control access point 120. In applications wherein the present invention is not applied, there is typically a lighting switch installed in control access point 120, sometimes attached to a dimmer.

In an embodiment, a lighting switch 124 and an input stage 141 of a lighting control device 128 are connected in series along AC supply line 116 in control access point 120. Control device 128 typically operates as a remote controller of LED driver 108. Input stage 141 comprises a zener diode 136 connected in series with a diode pair 140, together constituting a voltage limiter having a peak-to-peak voltage equal to the sum of the zener breakdown voltage and the knee voltages of the zener diode and each of diodes 140. When switch 124 is in ON position, input stage 141 converts the input current of LED driver 108, flowing through AC supply line 116, to an input AC voltage 142 supplied to an AC/DC converter 144. Input AC voltage 142 thus has the above peak-to-peak value, which is substantially smaller than AC supply 103. AC/DC converter 144 converts input AC voltage 142 to an output DC voltage 143 supplied to a lighting control circuit 130. Lighting control circuit 130 then controls LED driver 108, as explained hereinafter.

However, the power consumption of input stage 141 affects the efficiency of lighting system 100 and, in case of high power lighting system, might result in excess heating of control access point 120. In order to mitigate this problem, a limiter control circuit is employed in an embodiment, comprising a control line 146, a switch 148 and a detection circuit within AC/DC converter 144, not shown in FIG. 1A. The limiter control circuit operates as follows:

During a few milliseconds after lighting control device 128 is turned on, e.g. by turning switch 124 to ON position, switch 148 is in OFF position, allowing voltage limiter 138 & 140 to supply a sufficiently high initial input AC voltage to AC/DC converter 144. This initial input AC voltage has a peak-to-peak value equal to the breakdown voltage of zener diode 136 plus three times diode knee voltage. When the detection circuit detects that the AC/DC converter has reached an operating state that allows it to continue operation without resorting to high input AC voltage, it causes control line 146 to turn switch 148 to ON position. Consequently, input AC voltage 142 reduces to about 1.4 volt peak-to-peak, determined by diode pair 140. In an embodiment, switch 148 comprises a transistor, not shown in FIG. 1A, for shortcutting zener diode 136. In other embodiments, switch 148 is realized by a mechanical switch such as a reed relay.

Referring again to lighting control circuit 130, its main role is to produce and send control information to LED driver 108. In an embodiment, such control information may be, for instance, lighting intensity adjustment, i.e. a dimming command initiated by a user of lighting system 100 through a user interface 149. The user interface may be a dimming knob, a Man Machine Interface (MMI) comprising a touch screen or any other suitable interface.

In an embodiment, lighting control circuit 130 transfers the control information to LED driver 108 through a Radio Frequency (RF) transformer 150, whose secondary winding is connected in series with AC supply line 116 and whose primary winding is coupled to the lighting control circuit.

FIG. 1B shows a block diagram that schematically illustrates a lighting system 101, in accordance with an alternative embodiment of the present invention. In this embodiment, intended for relatively low power lighting systems, limiter control circuit 146 & 148 is omitted and the voltage limiter consists of zener diode 136 only. Consequently, input AC voltage 142 retains its initial value, of several volts, as long as lighting control device 128 is operating.

In the embodiment illustrated in FIG. 1B, also transformer 150 is missing and substituted by a choke 152 and a coupling capacitor 156 for transmitting the control information to LED driver 108 through AC supply line 116.

FIG. 1C shows a block diagram that schematically illustrates a lighting system 102, in accordance with yet an alternative embodiment of the present invention. In this embodiment, the voltage limiter consists of diode pair 140 only, thereby providing AC/DC converter 144 with a low peak-to-peak voltage of about 1.4 volt. Therefore, AC/DC converter 144 comprises a voltage-raising stage at its input, realized in the described embodiment by a voltage-raising transformer 160, which saves the complexity of the above limiter control circuit at the expense of additional volume of lighting control device 128.

In lighting system 102, the control information transfer is based on a wireless transmitter 164 and a wireless link 168 connecting lighting control circuit 160 with LED driver 108.

In yet alternative embodiments, any other suitable combination of the above techniques for producing input AC voltage 142 and for sending control information to LED driver 108 can be applied, as well as any other suitable techniques based on the above, that may be obvious to persons of ordinary skill in the art.

The above description has focused on the specific elements of lighting systems 100, 101, 102 and particularly of lighting control device 128, that are essential for understanding certain features of the disclosed techniques. Conventional elements that are not needed for this understanding have been omitted from FIGS. 1A, 1B and 1C for the sake of simplicity but will be apparent to persons of ordinary skill in the art. Furthermore, the configurations shown above are example configuration, which were chosen purely for the sake of conceptual clarity. In alternative embodiments, any other suitable configurations can also be used.

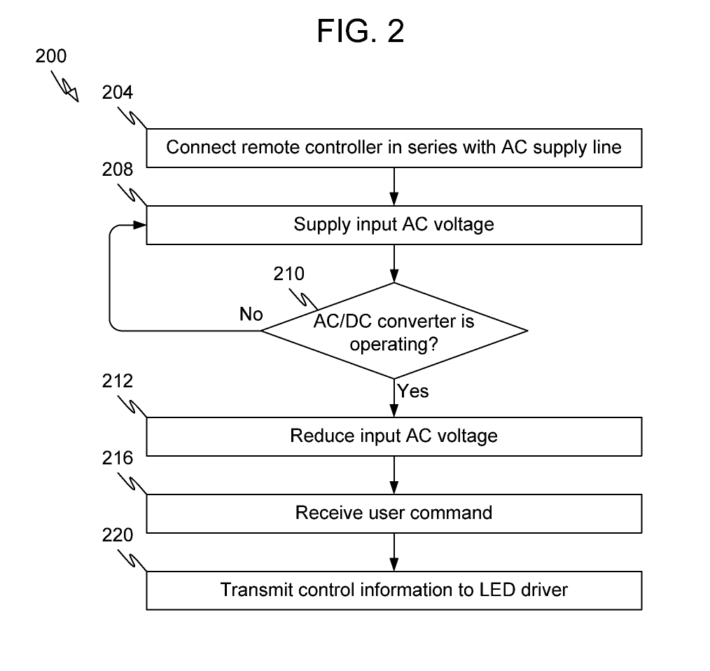

FIG. 2 shows a flowchart 200 which schematically illustrates a method of controlling a LED driver from a control access point, in accordance with an embodiment of the present invention. The method begins with a connecting step 204, wherein lighting control device 128 is connected along AC supply line 116 which leads AC power to LED driver 108. Next, in a supplying step 208, input stage 141 supplies input AC voltage 142 to AC/DC converter 144. In step 210, the detection circuit within AC/DC converter 144 checks whether the AC/DC converter has reached an operating state that allows it to continue its operation without resorting to high input AC voltage. This checking condition is illustrated in flowchart 200 by a return line from step 210 to step 208.

Upon a positive result in step 210, the method proceeds to a reducing step 212, in which limiter control circuit 146 & 148 shortcuts zener diode 136 for reducing input AC voltage 142. In a receiving step 216 lighting control device 128 receives user commands through user interface 149. Finally, in a transmitting step 220, lighting control circuit 130 converts the user commands to control information and transmits it in a predefined format to LED driver 108.

The flowchart shown in FIG. 2 is an example flowchart, which was chosen purely for the sake of conceptual clarity. In alternative embodiments, any other suitable flowchart can also be used for illustrating the disclosed method. Method steps that are not mandatory for understanding the disclosed techniques were omitted from FIG. 2 for the sake of simplicity.

Although the embodiments described herein mainly address LED lighting, the methods and systems exemplified by these embodiments can also be used in other lighting applications.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A lighting control device comprising:
an input stage connected along an AC supply line of a lighting driver, said input stage being configured to convert an input current of the lighting driver flowing through the AC supply line to a substantially small AC voltage;
an AC/DC converter coupled to receive said substantially small AC voltage as an input AC voltage and to convert it to an output DC voltage; and
a lighting control circuit coupled to receive said output DC voltage as a power source and configured to transmit control information to the lighting driver.

2. The lighting control device of claim 1, wherein said input stage comprises a voltage limiter configured to determine said substantially small AC voltage.

3. The lighting control device of claim 2, further comprising a limiter control circuit configured to reduce said substantially small AC voltage upon detecting that said AC/DC converter has reached an operating state, thereby saving power consumption of said input stage.

4. The lighting control device of claim 3, wherein said limiter control circuit comprises a switch, and is configured to reduce said input AC voltage by causing said switch to shortcut a part of said voltage limiter.

5. The lighting control device of claim 2, wherein said AC/DC converter comprises a voltage-raising stage.

6. The lighting control device of claim 5, wherein said voltage-raising stage comprises a transformer.

7. The lighting control device of claim 1, wherein said lighting control circuit comprises a wireless transmitter for transmitting said control information to the lighting driver.

8. The lighting control device of claim 1, wherein said lighting control circuit is configured to transmit said control information to the lighting driver through the AC supply line.

9. The lighting control device of claim 8, further comprising a coupling capacitor that couples between said lighting control circuit and the AC supply line, wherein said lighting control circuit is configured to transmit said control information to the lighting driver through the AC supply line and said coupling capacitor.

10. The lighting control device of claim 8, further comprising a radio frequency (RF) transformer whose secondary winding is connected in series with the AC supply line and whose primary winding is coupled to said lighting control circuit, wherein said lighting control circuit is configured to transmit said control information to the lighting driver through the AC supply line and said RF transformer.

11. The lighting control device of claim 1, further comprising a user interface coupled to said lighting control circuit, wherein said lighting control circuit is further configured to receive one or more control commands from a user of the lighting control device through said user interface and to produce said control information based on said control commands.

12. The lighting control device of claim 11, wherein said one or more control commands comprise a dimming command.

13. A method of controlling a lighting driver, comprising the steps of:
connecting a lighting control device along an AC supply line of the lighting driver, said lighting control device comprising an input stage, an AC/DC converter and a lighting control circuit;
converting an input current of the lighting driver flowing through the AC supply line to an input voltage to the AC/DC converter;
converting said input voltage to an output DC voltage by said AC/DC converter;
using said output DC voltage for supplying power to a lighting control circuit; and
transmitting control information to the lighting driver from said lighting control circuit.

14. The method of claim 13, further comprising the step of determining said substantially small AC voltage by a voltage limiter.

15. The method of claim 14, wherein determining said substantially small AC voltage by said voltage limiter comprises reducing said input AC voltage when said AC/DC converter reaches an operating state, thereby saving power consumption of said voltage limiter.

16. The method of claim 15, wherein reducing said input AC voltage is performed by shortcutting a part of said voltage limiter.

17. The method of claim 13, wherein transmitting said control information to the lighting driver is performed by means of a wireless transmitter.

18. The method of claim 13, wherein transmitting the control information to the lighting driver comprises using the AC supply line as a transmission medium.

19. The method of claim 18, wherein using the AC supply line as a transmission medium comprises coupling thereto by a coupling capacitor.

20. The method of claim 18, wherein using the AC supply line as a transmission medium comprises coupling thereto by a radio frequency (RF) transformer.

21. The method of claim 13, further comprising the step of producing said control information based on one or more control commands received from a user of the lighting control device.

22. The method of claim 21, wherein said one or more control commands comprises a dimming command.
